(19) United States
(12) Patent Application Publication
(10) Pub. No.: US 2003/0164889 A1
(43) Pub. Date: Sep. 4, 2003

(54) Solid-state imaging device and correlated double sampling circuit

(76) Inventor: Yukio Koyanagi, Saitama-shi (JP)

Correspondence Address: CONNOLLY BOVE LODGE & HUTZ LLP, SUITE 800, 1990 M STREET NW, WASHINGTON, DC, 20036-3425, US

(21) Appl. No.: 10/397,340

(22) Filed: Mar. 27, 2003

Related U.S. Application Data
(63) Continuation of application No. PCT/JP01/08334, filed on Sep. 26, 2001.

(30) Foreign Application Priority Data
Sep. 27, 2000 (JP) 2000-293302

(51) Int. Cl. H04N 5/335

(52) U.S. Cl. 348/308

(57) ABSTRACT

A CDS circuit (20) is provided with a clamping circuit (21,22) for clamping the output signal of a solid-state imaging device to a signal potential and an S/H circuit (24, 25) for sampling the differential potential between the clamped signal potential and a reference potential. The output signal is clamped to the signal potential by applying a first clamping pulse CP1 before the accumulated charge reset of the solid-state imaging device and applying a second clamping pulse CP2 after the accumulated charge reset so as to sample and hold the differential potential. Thus, the CDS circuit (20) can perform a clamping and a sample-and-hold operation along the stream (stream of time) of the signal outputted from the solid-state imaging device. As a result it is unnecessary to provide any S/H circuit for delaying the signal potential by a predetermined time in the solid-state imaging device.

### BACKGROUND OF THE INVENTION

1. Field of the Invention

The present invention relates to a solid-state imaging device and system and a correlated double sampling circuit, and in particular, it is suitable for use in a MOS-type solid-state imaging device of a X-Y address type and the correlated double sampling circuit to be used in conjunction with it.

2. Description of the Related Art

In general, various types of solid-state imaging devices are classified into a CCD transfer type using a CCD (Charge Coupled Device) and an X-Y address type using an X-Y selection network for selecting two-dimensionally arranged pixels and reading charges. Many of the solid-state imaging devices of the X-Y address type are constituted by using MOS transistors.

An MOS-type solid-state imaging device has an advantage over a CCD-type solid-state imaging device in that its power consumption is low and miniaturization is easy. For that reason, attention is focused on use of the MOS-type solid-state imaging device, in spite of its image quality inferior to that of the CCD-type solid-state imaging device, for a camera of a small information technology device such as a portable telephone or a PDA (Personal Digital Assistants) of which lower power consumption and miniaturization are more emphasized than the image quality.

FIG. 1 is a diagram showing a basic configuration of the MOS-type solid-state imaging device. As shown in FIG. 1, the two-dimensionally arranged pixels are equipped with a photodiode 101 which is a photoelectric conversion element and an MOS transistor for a vertical scan (hereafter, referred to as a vertical scan transistor) 102 respectively. A gate of the vertical scan transistor 102 is connected to a vertical scan line 103, and a source and a drain are connected to the photodiode 101 and a vertical signal line 104.

Each vertical scan line 103 is connected to a vertical scan circuit 107. In addition, each vertical signal line 104 is connected to the source of an MOS transistor for a horizontal scan (hereafter, referred to as a horizontal scan transistor) 105. The gate of the horizontal scan transistor 105 is connected to a horizontal scan circuit 108 via a horizontal scan line 106, and the drain is connected to a signal output line 109. An MOS-type solid-state imaging device 100 is comprised of the above.

Next, operation of the MOS-type solid-state imaging device 100 thus constituted will be described. The vertical scan circuit 107 generates a vertical scan pulse for selecting each vertical scan line 103 in order and supplies it to each vertical scan line 103 in order. Thus, a plurality of the vertical scan transistors 102 connected to the vertical scan line 103 to which the vertical scan pulse was supplied are sequentially turned on each horizontal line.

If the vertical scan transistors 102 are turned on, signal charges accumulated in the corresponding photodiodes 101 until then are sent to the vertical signal lines 104. As opposed to this, the photodiodes 101 of the pixels corresponding to the vertical scan lines 103 to which no vertical scan pulse is supplied continue accumulation of the charges as-is.

The horizontal scan circuit 108 generates a horizontal scan pulse for selecting each horizontal scan line 106 in order and supplies it to each horizontal scan line 106 in order during one vertical period (1V period) in which a certain vertical scan line 103 is selected. Then, the horizontal scan transistors 105 connected to the horizontal scan lines 106 to which the horizontal scan pulses were supplied are sequentially turned on.

Thus, the signal charges taken to each vertical signal line 104 out of a plurality of the photodiodes 101 corresponding to a certain vertical scan line 103 are sequentially brought out to the signal output line 109 via the horizontal scan transistor 105 so as to be outputted as picture signals. In this case, during one horizontal period (1H period) in which a certain horizontal scan transistor 105 is in conduction, accumulated charges of the corresponding photodiode 101 are reset, and an initial potential for accumulating the charges is set before reading them next time.

Such a vertical scan and a horizontal scan are repeatedly performed so that the signal charges of all the pixels are sequentially taken out to the signal output line 109. Such a scan technique is called all-pixel sequential scanning.

As for the MOS-type solid-state imaging device 100, the vertical scan pulses and the horizontal scan pulses are independent on each vertical scan line 103 and on each horizontal scan line 106, and so all the pulses do not necessarily become the same. In addition, there are variations in electrical properties of the vertical scan transistors 102 and the horizontal scan transistors 105, so that a fixed pattern noise (FPN) of each pixel occurs when reading the signal charges. Furthermore, a switching noise occurs in conjunction with reset operation of the photodiodes 101.

In the past, a correlated double sampling (CDS) circuit 110 was used in a subsequent stage of the MOS-type solid-state imaging device 100 in order to hold down these noises. The CDS circuit 110 clamps to a fixed voltage a reference level of each clock cycle of a waveform as to an output signal of the MOS-type solid-state imaging device 100, and further samples and holds (S/H) a signal level to obtain a differential potential between the reference level and signal level so as to reduce the fixed pattern noise and reset noise.

FIG. 2 is a diagram showing a configuration of the CDS circuit 110 of the prier art. In FIG. 2, reference numeral 111 denotes a switch for clamping comprised of the MOS transistor and so on, 112 denotes a clamp capacity, 113 denotes an amplifier, and 114 denotes a switch for S/H comprised of the MOS transistor and so on, and 115 denotes an S/H capacity.

FIG. 3 is a wave form chart for explaining the operation of the CDS circuit 110. Hereafter, the operation of the CDS circuit 110 will be described by using FIGS. 2 and 3.

To begin with, a first clamp pulse CP1 is applied to the switch for clamping 111, and the reference level after accumulated charge reset of the signal inputted to a minus side of the amplifier 113 (an initial potential of charge accumulating operation of the photodiodes 101) is clamped to a fixed potential by the clamp capacity 112.

After accumulating the charge with the photodiodes 101 for a fixed period thereafter, a second clamp pulse CP2 is applied to the switch for S/H 114. Thus, the signal outputted from the amplifier 113, that is, the differential potential between the signal level of a read charge from the photodiodes 101 and the reference level (output signal voltage V_{sig} shown in FIG. 3) is sampled.

The above operation is repeatedly performed at the clock cycle of each pixel so that the variations of each pixel are canceled and the fixed pattern noise, reset noise and so on of each pixel are held down.

As described above, the CDS circuit 110 in the past shown in FIG. 2 clamps to the fixed voltage the reference level of charge accumulation as to the output signal of the MOS-type solid-state imaging device 100 by applying the first clamp pulse CP1, and samples and holds the differential potential between the clamped reference level and signal level by applying the second clamp pulse CP2.

However, as shown in FIG. 3, the output signal voltage V_{sig} of the amplifier 113 is generated in reality from the difference between the signal level sampled and held by turning on the second clamp pulse CP2 and the reference level clamped by turning on the first clamp pulse CP1 thereafter. To be more specific, the timing of applying the first and second clamp pulses CP1 and CP2 is temporally reversed by the timing of obtaining the signal to be used for generation of the output signal voltage V_{sig}.

Therefore, the CDS circuit 110 does not operate well as-is. Thus, in the past, the signal level sampled by applying the second clamp pulse CP2 was sampled and held, and it was delayed until after the timing of having the reference level clamped by applying the first clamp pulse CP1 thereafter (dashed line arrow in FIG. 3). For that reason, it was necessary to have an S/H circuit separately provided.

FIG. 4 is a diagram showing the configuration of the MOS-type solid-state imaging device having the S/H circuit of the prier art. In FIG. 4, those given the same symbols as in FIG. 1 have the same functions, and so a repeated description thereof will be omitted here.

As shown in FIG. 4, the S/H circuit comprised of an MOS transistor 121 and a capacity 122 is provided between the vertical signal line 104 and the horizontal scan transistor 105.

The S/H circuit is operated by supplying an S/H pulse to a control signal line 123. In this case, a signal load brought out to the vertical signal line 104 by the photodiodes 101 is held by the S/H circuit just for a predetermined period. And it is sent to the signal output line 109 via the horizontal scan transistor 105 so as to be supplied to the CDS circuit 110. It thereby allows the operation of the CDS circuit 110 described by using the above FIGS. 2 and 3.

However, the above prior art had a problem that it required the S/H circuit to be provided inside the MOS-type solid-state imaging device for the sake of a correlated double sampling process and the structure accordingly becomes complicated. In recent years, the MOS-type solid-state imaging device is often used for a small information technology device, and miniaturization of the information technology device itself is underway. Therefore, the existence of the S/H circuit is one of the factors in difficulty of the miniaturization at the present day when further miniaturization of the circuit scale of the MOS-type solid-state imaging device is desired.

The present invention has been implemented in order to solve such a problem, and an object thereof is to leave out the S/H circuit used in the past for the correlated double sampling process and allow further miniaturization of the circuit scale of the MOS-type solid-state imaging device.

### SUMMARY OF THE INVENTION

The solid-state imaging device according to the present invention is characterized by having in each of two-dimensionally arranged pixels a photoelectric converter, first and fourth MOS transistors for vertical scanning, a second MOS transistor for horizontal scanning, third and fifth MOS transistors for accumulated charge resetting of the photoelectric converter, and also having a scan circuit for generating first and second vertical scan pulses for turning on the first and fourth MOS transistors, a horizontal scan pulse for turning on the second MOS transistor, and a reset pulse for turning on the third and fifth MOS transistors, wherein the scan circuit generates the second vertical scan pulse in arbitrary timing which is the same as or different from the first vertical scan pulse.

A still further aspect of the present invention is characterized by serially connecting the first MOS transistor to a set of the second and third MOS transistors connected in parallel, serially connecting the fourth MOS transistor to the fifth MOS transistor, connecting a set of the first to third MOS transistors and a set of the fourth and fifth MOS transistors in parallel with the photoelectric converter, connecting the other end of the second MOS transistor to the signal output line and connecting the other ends of the third and fifth MOS transistors to the power supply.

A correlated double sampling circuit according to the present invention is characterized by having a clamp circuit for clamping a signal outputted from a solid-state imaging device to a signal potential, an amplifier circuit for outputting a differential potential between the signal potential clamped by the clamp circuit and a reference potential, and a sample-and-hold circuit for sampling the signal outputted from the amplifier circuit.

Another aspect of the present invention is characterized by applying a first pulse for operating the clamp circuit before the accumulated charge reset operation of the solid-state imaging device and applying a second pulse for operating the sample-and-hold circuit after the accumulated charge reset operation of the solid-state imaging device.

In addition, a solid-state imaging system according to the present invention is characterized by comprising a solid-state imaging device having in each of two-dimensionally arranged pixels a photoelectric converter, a first MOS transistor for vertical scanning, a second MOS transistor for horizontal scanning and a third MOS transistor for accumulated charge resetting of the photoelectric converter and also having a scan circuit for generating a vertical scan pulse, horizontal scan pulse and reset pulse for turning on the first to third MOS transistors, and the correlated double sampling circuit including a clamp circuit for clamping a signal outputted from the solid-state imaging device to a signal potential, an amplifier circuit for outputting a differential potential between the signal potential clamped by the clamp circuit and a reference potential, and a sample-and-hold circuit for sampling the signal outputted from the amplifier circuit.

As the present invention is comprised of the above technical means, the vertical scan pulses, horizontal scan pulse and reset pulse are applied on the solid-state imaging device in adequate timing so that the signal potential after charge accumulation, reset potential and initial potential of the charge accumulation appear in order on the signal output line of the solid-state imaging device. On the correlated double sampling circuit, an output signal of the solid-state imaging device is clamped to the signal potential first before the reset operation of the solid-state imaging device, and after the reset is performed, the differential potential between the clamped signal potential and the initial potential after the accumulated charge reset is sampled and held. Thus, a difference between two sample values is acquired so as to hold down a fixed pattern noise and a reset noise superposed on the reference potential and so on. Of these operations, a clamp operation and a sample-and-hold operation on the correlated double sampling circuit can be performed along a flow of the signals (passage of time) outputted from the solid-state imaging device so that it is no longer necessary to provide an S/H circuit for delaying the signal potential for a fixed period. Therefore, it is possible to simplify the configuration of the solid-state imaging device and realize miniaturization thereof. Further, the second vertical scan pulse is applied in arbitrary timing which is the same as or different from the first vertical scan pulse so that it is possible to freely change the time for charge accumulation and realize an electronic shutter operation.

### BRIEF DESCRIPTION OF THE DRAWINGS

FIG. 1 is a diagram showing a basic configuration of the MOS-type solid-state imaging device;

FIG. 2 is a diagram showing a configuration of the CDS circuit of the prier art;

FIG. 3 is a wave form chart showing operation of the CDS circuit of the prier art;

FIG. 4 is a diagram showing the configuration of the MOS-type solid-state imaging device having an S/H circuit of the prier art;

FIG. 5 is a diagram showing a configuration example of the MOS-type solid-state imaging device according to a first embodiment;

FIG. 6 is a diagram showing a configuration example of the CDS circuit according to the embodiment;

FIG. 7 is a timing chart showing an operation example of the MOS-type solid-state imaging device and CDS circuit according to the embodiment; and

FIG. 8 is a diagram showing a configuration example of the MOS-type solid-state imaging device according to a second embodiment.

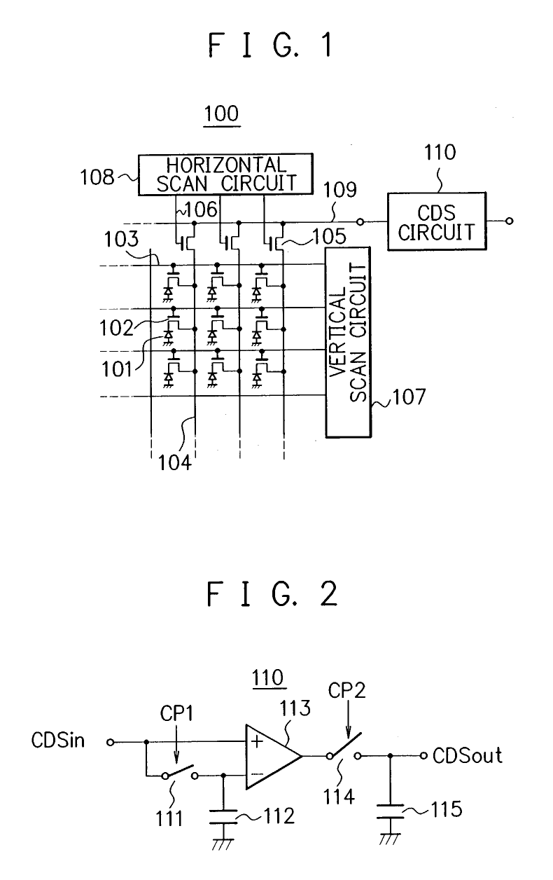

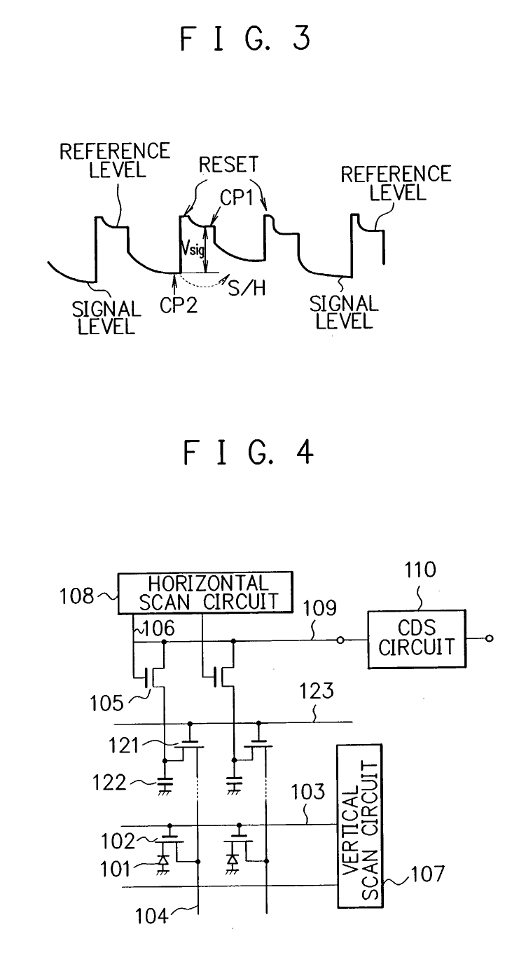

### DETAILED DESCRIPTION OF THE PREFERRED EMBODIMENTS

Hereafter, an embodiment of the present invention will be described based on the drawings.

First Embodiment

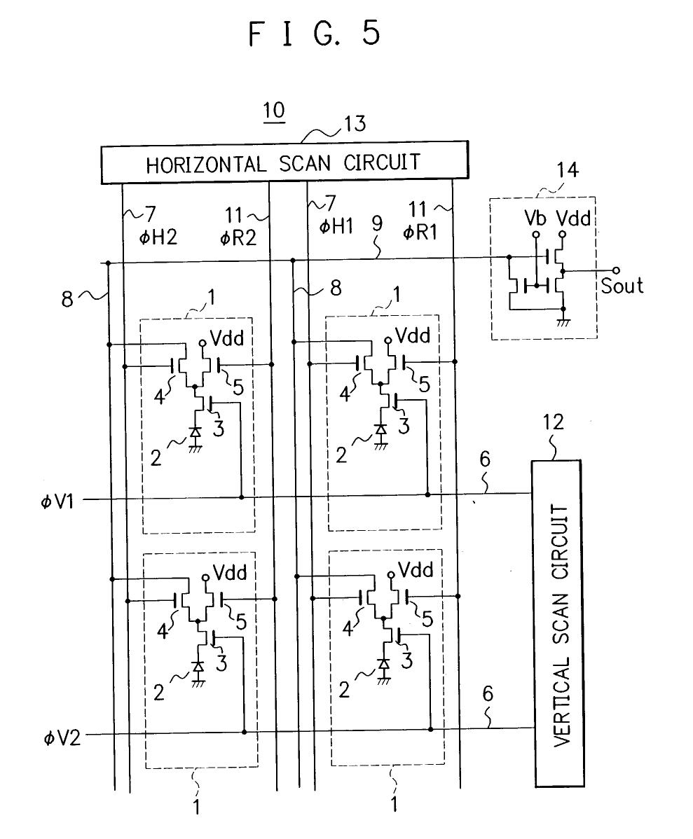

FIG. 5 is a diagram showing a configuration example of a part of an MOS-type solid-state imaging device 10 according to a first embodiment.

As shown in FIG. 5, each of the two-dimensionally arranged pixels 1 has a photodiode 2 which is a photoelectric converter, a vertical scan transistor 3, a horizontal scan transistor 4 and a reset transistor 5. And the vertical scan transistor 3 is serially connected to the photodiode 2, and a set of the horizontal scan transistor 4 and reset transistor 5 connected in parallel is serially connected to the vertical scan transistor 3.

To be more specific, a gate of the vertical scan transistor 3 is connected to a vertical scan line 6, a source is connected to the photodiode 2, and a drain is connected to a common node of the horizontal scan transistor 4 and reset transistor 5. The gate of the horizontal scan transistor 4 is connected to a horizontal scan line 7, and the drain is connected to a signal output line 9 via a vertical signal line 8. The gate of the reset transistor 5 is connected to a reset control line 11, and the source is connected to a power supply Vdd.

Each vertical scan line 6 is connected to a vertical scan circuit 12, and each horizontal scan line 7 and each reset control line 11 are connected to a horizontal scan circuit 13. The signal output line 9 is connected to an output circuit 14, and an output signal of the MOS-type solid-state imaging device 10 is sent from here to a CDS circuit 20 in the next stage. Vb in the output circuit 14 is a bias voltage.

The vertical scan circuit 12 generates vertical scan pulses φV1, φV2, . . . for selecting each vertical scan line 6 in order, and supplies them to each vertical scan line 6 in order. Thus, a plurality of the vertical scan transistors 3 connected to the vertical scan lines 6 to which the vertical scan pulses φV1, φV2, . . . were supplied are sequentially turned on by horizontal line.

The horizontal scan circuit 13 generates horizontal scan pulses φH1, φH2, . . . for selecting each horizontal scan line 7 in order during 1V period in which a certain vertical scan line 6 is selected, and supplies them to each horizontal scan line 7 in order. Then, the horizontal scan transistors 4 connected to the horizontal scan lines 7 to which the horizontal scan pulses φH1, φH2, . . . were supplied are sequentially turned on.

Thus, signal charges are taken to the vertical signal lines 8 out of the photodiode 2 of the pixels 1 having both the vertical scan transistor 3 and horizontal scan transistor 4 in conduction, and are sent to the output circuit 14 via the signal output line 9. And they are outputted as picture signals from the output circuit 14 to the CDS circuit 20 in the next stage.

In this case, the horizontal scan circuit 13 generates reset pulses φR1, φR2, . . . for selecting each reset control line 11 in order at a predetermined point in time during 1H period in which the horizontal scan pulses φH1, φH2, . . . are outputted, and supplies them to each reset control line 11 in order. Then, the reset transistors 5 connected to the reset control lines 11 to which the reset pulses φR1, φR2, . . . were supplied are sequentially turned on.

Thus, a power-supply voltage Vdd is charged to the photodiode 2 via the reset transistor 5 and vertical scan transistor 3, and accumulated charges of the photodiode 2 are reset. Thus, an initial potential (reference level) for accumulating the charges is set on the photodiode 2 before reading them next time.

The signal charges of all the pixels are sequentially taken out to the signal output line 9, by repeatedly performing the above vertical scan and horizontal scan, to be outputted from the output circuit 14 to the CDS circuit 20 in the next stage.

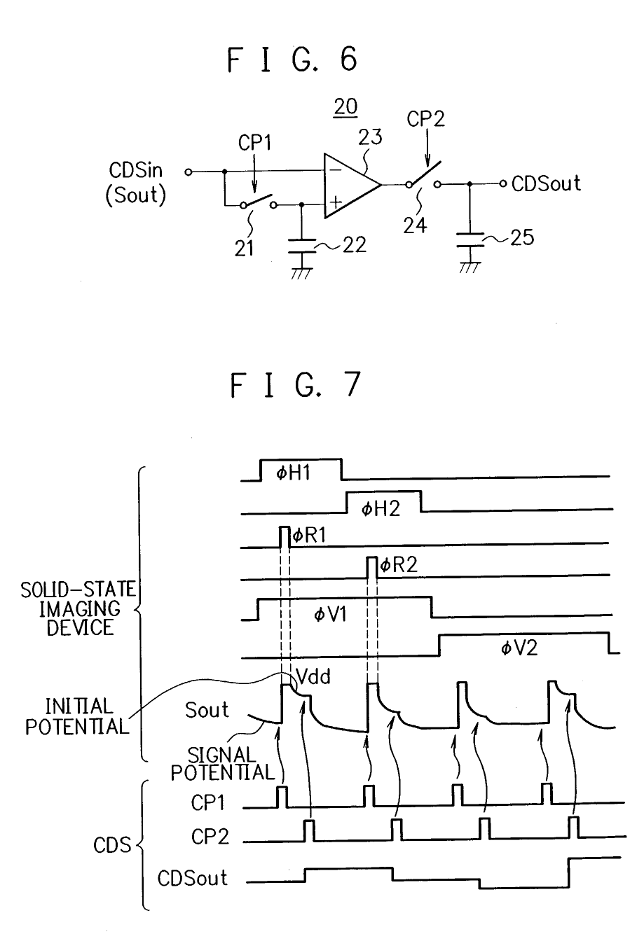

FIG. 6 is a diagram showing a configuration example of the CDS circuit 20 according to this embodiment. In FIG. 6, reference numeral 21 denotes a switch for clamping comprised of the MOS transistor and so on, 22 denotes a clamp capacity, 23 denotes an amplifier, and 24 denotes a switch for S/H comprised of the MOS transistor and so on, and 25 denotes an S/H capacity.

The CDS circuit 20 according to this embodiment has the signs on an input side of the amplifier 23 inverted compared to an amplifier 113 in the past shown in FIG. 2. To be more specific, the past example shown in FIG. 2 clamps the reference level of the signal charges inputted to the minus side of the amplifier 113, whereas the embodiment in FIG. 6 clamps the signal level of the signal charges inputted to the plus side of the amplifier 23. Thus, the amplifier 23 in FIG. 6 outputs a differential potential of inverted signs compared to the case of the amplifier 113 shown in FIG. 2.

Thus, the CDS circuit 20 according to this embodiment clamps the signal level of the signal charges by using the clamp capacity 22. This signal level changes according to the time of accumulating the charges on the photodiode 2 and incident light volume. For that reason, it is desirable to render a capacity value of the clamp capacity 22 rather small (0.1 μF or less for instance) to be able to cope with a minor change in the signal level to be clamped.

Hereafter, the operation of the CDS circuit 20 will be described. The signal outputted from the MOS-type solid-state imaging device 10 is supplied to the amplifier 23, where a differential signal between the signal level on reading the charge and the reference level after the reset operation is generated. In this case, first, the potential is clamped to the signal level with the clamp capacity 22 by applying a first clamp pulse CP1 to a switch for clamping 21 on reading the charge. Next, a second clamp pulse CP2 is applied to the switch for S/H 24 after the reset operation of the photodiode 2 is performed so that the differential potential of inverted signs generated by the amplifier 23 is held by the S/H capacity 25.

Thus, this embodiment first clamps the signal level by applying the first clamp pulse CP1, and after the photodiode 2 is reset thereafter, it applies the second clamp pulse CP2 to sample and hold the inverted differential potential. To be more specific, the level to be clamped and the level to be sampled and held are inverted from the cases in the past. As described above, the output signal voltage V_{sig} is determined by the difference between the reference level and the signal level, and so a correct output signal voltage V_{sig} can be obtained even in the case of the differential potential of inverted signs.

FIG. 7 is a timing chart for explaining the operation of the MOS-type solid-state imaging device 10 and CDS circuit 20 according to this embodiment. FIG. 7 shows the operation of the four pixels 1 shown in FIG. 5, and in particular, the two pixels 1 connected to the upper vertical scan line 6.

In FIG. 7, the MOS-type solid-state imaging device 10 sequentially applies the horizontal scan pulses φH1, φH2 by 1H period during the 1V period in which the vertical scan pulse φV1 is applied, and also sequentially applies the reset pulses φR1, φR2 in predetermined timing in each 1H period. Thus, the signal charges are accumulated and read in the pixels 1 selected by these pulses.

This operation causes the signal potential (signal level) on reading the charges, reset potential (Vdd) and initial potential (reference level) of the charge accumulation to appear in this order on the signal output line 9 (Sₒᵤₜ) of the MOS-type solid-state imaging device 10. The initial potential of the charge accumulation is a level wherein the potential charged up to the power-supply voltage Vdd by applying the reset pulses φR1, φR2 is reduced by an equivalent of a field-through component due to a parasitic capacitance and so on generated between the horizontal scan transistor 4 and reset transistor 5.

On reading the charges on the MOS-type solid-state imaging device 10, the first and second clamp pulses CP1 and CP2 are applied to the CDS circuit 20 as follows. For instance, during the 1H period in which the first horizontal scan pulse φH1 is applied, the first clamp pulse CP1 is applied to the CDS circuit 20 first, and the potential is thereby clamped to the signal level of the signal charge read from the photodiode 2.

Immediately after that, on the MOS-type solid-state imaging device 10, the potential is set at the reference level of the charge accumulation after the reset pulse φR1 is applied and the photodiode 2 is charged up to the power-supply voltage Vdd. Thereafter, the second clamp pulse CP2 is applied to the CDS circuit 20 so as to sample the signal outputted from the amplifier 23, that is, the differential potential between the reference level and signal level of which signs are inverted.

This operation is also performed sequentially from the second horizontal scan pulse φH2 onward so that the variations of each pixel are canceled and the fixed pattern noise and reset noise of each pixel are held down.

As described above, according to this embodiment, the CDS circuit 20 is comprised of the circuit of which signs are inverted compared to the one in the past. And the signal level is clamped first by applying the first clamp pulse CP1 before resetting the photodiode 2, and the second clamp pulse CP2 is applied after the photodiode 2 is reset thereafter so as to sample and hold the inverted differential potential.

It is thereby possible to perform a clamp operation and a sample-and-hold operation on the CDS circuit 20 along a flow of the signals (passage of time) outputted from the MOS-type solid-state imaging device 10 so that it is no longer necessary to provide the S/H circuit for delaying the signal level for a fixed period to the MOS-type solid-state imaging device 10. Therefore, it is possible to simplify the configuration of the MOS-type solid-state imaging device 10 and miniaturize an information technology device using it.

Moreover, it is also feasible to provide the reset transistors 5 at one point on the signal output line 9 instead of providing it in each pixel. In that case, however, a reset current generated in conjunction with switching increase so that the reset noise becomes significant. As opposed to this, it is possible to place the reset transistors 5 in a dispersed state among the pixels 1 and perform a reset charge by using the power supply Vdd as close as possible to the ground of the photodiode 2 (to shorten a path) as in the above embodiment so as to disperse and reduce the reset noise and further hold down the noise with the CDS circuit 20 in the next stage.

Second Embodiment

Next, a second embodiment of the present invention will be described.

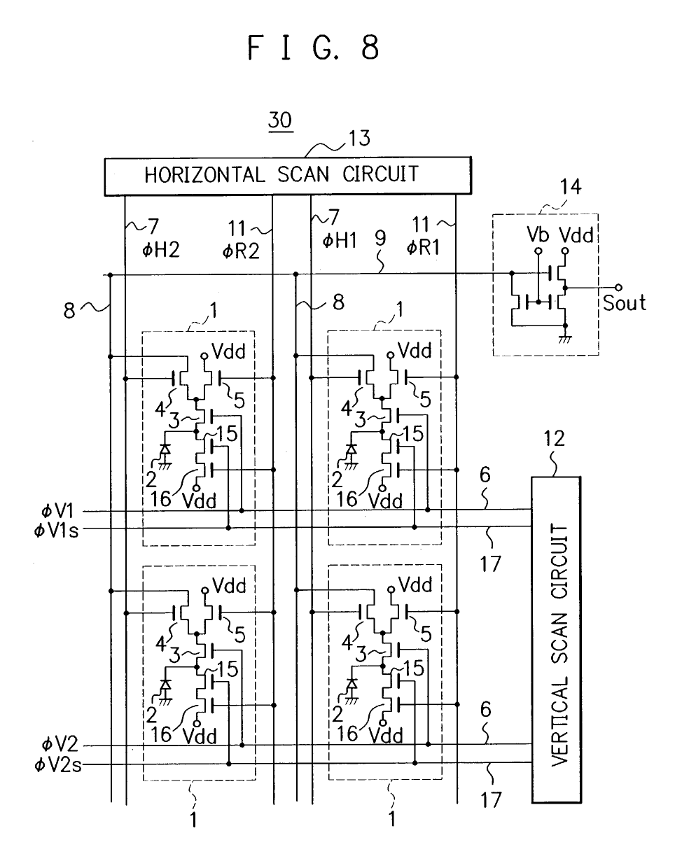

FIG. 8 is a diagram showing a configuration example of a part of a MOS-type solid-state imaging device 30 according to a second embodiment. In FIG. 8, those given the same symbols as in FIG. 5 have the same functions, and so a repeated description thereof will be omitted here.

As shown in FIG. 8, the MOS-type solid-state imaging device 30 according to a second embodiment has two vertical scan lines 6 and 17 on each horizontal line. The vertical scan lines 6 and 17 are connected to the vertical scan circuit 12. Each pixel 1 of the MOS-type solid-state imaging device 30 has two MOS transistors 15, 16 serially connected to the power supply Vdd in addition to the configuration shown in FIG. 5.

The gate of the MOS transistors 15 is connected to the vertical scan line 17, and the gate of the MOS transistors 16 is connected to a reset control line 10. In addition, a set of transistors comprised of the two MOS transistors 15, 16 and another set of transistors comprised of the vertical scan transistor 3, horizontal scan transistor 4 and reset transistor 5 are connected in parallel with the photodiode 2.

The vertical scan circuit 12 generates the vertical scan pulses φV1s, φV2s, . . . for, in addition to the vertical scan pulses φV1, φV2, . . . for selecting each vertical scan line 6 in order, selecting another each vertical scan line 17 in order. Thus, a plurality of the vertical scan transistors 3 connected to the vertical scan lines 6 to which the vertical scan pulses φV1, φV2, . . . were supplied are sequentially turned on by horizontal line, and a plurality of the vertical scan transistors 15 connected to the vertical scan lines 17 to which the vertical scan pulses φV1s, φV2s, . . . were supplied are sequentially turned on by horizontal line.

Here, although the timing wherein the vertical scan circuit 12 generates the vertical scan pulses φV1, φV2, . . . for selecting each vertical scan line 6 may be the same as the timing wherein it generates the vertical scan pulses φV1s, φV2s, . . . for selecting each vertical scan line 17, they are not necessarily the same.

For instance, the vertical scan pulse φV1s is applied in arbitrary timing with no vertical scan pulse φV1 applied and the reset pulse φR1 is also applied so as to turn on the vertical scan transistors 15 and 16 selected by these pulses. Thus, the power-supply voltage Vdd is charged to the photodiode 2 through the MOS transistors 15 and 16 apart from the reset operation using the reset transistor 5 so as to perform the reset operation.

According to the first embodiment, the reset operation is performed by the reset transistor 5 without fail, and the time for charge accumulation from starting the charge accumulation until resetting is uniquely determined. As opposed to this, according to the second embodiment, the vertical scan pulses φV1s, φV2s, . . . are applied in the arbitrary timing different from the vertical scan pulses φV1, φV2,. . . , and the reset pulses φR1, φR2, . . . are also applied so that it is possible to freely change the time for charge accumulation and realize an electronic shutter operation.

In the second embodiment having thus constituted the MOS-type solid-state imaging device 30, the CDS circuit 20 to be placed in the subsequent stage can be constituted as in FIG. 6.

Each of the above-mentioned embodiments merely shows an example of concretization in implementing the present invention, and so the technical range of the present invention should not thereby be limitedly interpreted. To be more specific, it is possible to implement the present invention in various forms without deviating from the spirit or major characteristics thereof.

### INDUSTRIAL APPLICABILITY

The present invention is instrumental in leaving out the S/H circuit used for a correlated double sampling process in the past and allowing further miniaturization of a circuit scale of the MOS-type solid-state imaging device.

What is claimed is:

1. A solid state imaging device characterized by:
having in each of two-dimensionally arranged pixels a photoelectric converter, a first MOS transistor for vertical scanning, a second MOS transistor for horizontal scanning and a third MOS transistor for accumulated charge resetting of the photoelectric converter; and
also having a scan circuit for generating a vertical scan pulse for turning on the first MOS transistor, a horizontal scan pulse for turning on the second MOS transistor, and a reset pulse for turning on the third MOS transistor.

2. The solid state imaging device according to claim 1, characterized by:
serially connecting the first MOS transistor to the photoelectric converter, serially connecting to the first MOS transistor a set of the second and third MOS transistors connected in parallel; and
connecting the other end of the second MOS transistor to a signal output line and also connecting the other end of the third MOS transistor to a power supply.

3. A solid-state imaging device characterized by:
having in each of two-dimensionally arranged pixels a photoelectric converter, first and fourth MOS transistors for vertical scanning, a second MOS transistor for horizontal scanning,third and fifth MOS transistors for accumulated charge resetting of the photoelectric converter; and
also having a scan circuit for generating first and second vertical scan pulses for turning on the first and fourth MOS transistors, a horizontal scan pulse for turning on the second MOS transistor, and a reset pulse for turning on the third and fifth MOS transistors, and wherein:
the scan circuit generates the second vertical scan pulse in arbitrary timing which is the same as or different from the first vertical scan pulse.

4. The solid-state imaging device according to claim 3, characterized by:
serially connecting the first MOS transistor to a set of the second and third MOS transistors connected in parallel and serially connecting the fourth MOS transistor to the fifth MOS transistor;
connecting a set of the first to third MOS transistors and a set of the fourth and fifth MOS transistors in parallel with the photoelectric converter; and
connecting the other end of the second MOS transistor to the signal output line and connecting the other ends of the third and fifth MOS transistors to a power supply.

5. A correlated double sampling circuit characterized by having:
a clamp circuit for clamping a signal outputted from a solid-state imaging device to a signal potential;
an amplifier circuit for outputting a differential potential between the signal potential clamped by the clamp circuit and a reference potential; and
a sample-and-hold circuit for sampling the signal outputted from the amplifier circuit.

6. The correlated double sampling circuit according to claim 5, characterized by applying a first pulse for operating the clamp circuit before accumulated charge reset operation of the solid-state imaging device and applying a second pulse for operating the sample-and-hold circuit after the accumulated charge reset operation of the solid-state imaging device.

7. A solid-state imaging system characterized by comprising:
a solid-state imaging device having in each of two-dimensionally arranged pixels a photoelectric converter, a first MOS transistor for vertical scanning, a second MOS transistor for horizontal scanning and a third MOS transistor for accumulated charge resetting of the photoelectric converter and also having a scan circuit for generating a vertical scan pulse, horizontal scan pulse and reset pulse for turning on the first to third MOS transistors; and
a correlated double sampling circuit including a clamp circuit for clamping a signal outputted from the solid-state imaging device to a signal potential, an amplifier circuit for outputting a differential potential between the signal potential clamped by the clamp circuit and a reference potential, and a sample-and-hold circuit for sampling the signal outputted from the amplifier circuit.
